(19) United States
(12) Patent Application Publication
(10) Pub. No.: US 2026/0059309 A1
(43) Pub. Date: Feb. 26, 2026

(54) DATA CONTROL BASED ON THREAT CONDITION

(71) Applicant: Motorola Mobility LLC, Chicago, IL (US)

(72) Inventor: Ranjeet Gupta, Aurora, IL (US)

(73) Assignee: Motorola Mobility LLC, Chicago, IL (US)

(21) Appl. No.: 18/813,911

(22) Filed: Aug. 23, 2024

(51) Int. Cl. H04W 12/062; H04W 12/02; H04W 12/63

(52) U.S. Cl. CPC H04W 12/062; H04W 12/02; H04W 12/63

(57) ABSTRACT

Techniques for data control based on threat condition are described and are implementable to enable data transactions to be controlled based on threat conditions. For instance, a mobile device can receive sensor data indicating one or more threat condition triggers associated with a user of the mobile device. The mobile device can execute, based at least in part on the one or more threat condition triggers, a data control process to restrict one or more first data types from being transmitted by the mobile device.

### BACKGROUND

The use of network-based finance systems has become commonplace across the world. For instance, users can perform a wide variety of different financial transactions using a network-based finance application, such as using a portable device, e.g., a smartphone. While the availability of finance applications can provide a great deal of convenience, it is not without risks. For instance, the ability to easily access and transfer financial data (e.g., data representations of monetary value) can enable malicious actors to force users to enable access and transfer financial data against the users' will.

### BRIEF DESCRIPTION OF THE DRAWINGS

Aspects of data control based on threat condition are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of data control based on threat condition can be implemented.

FIG. 2 illustrates a signaling diagram in accordance with aspects of the present disclosure.

FIG. 3 illustrates a signaling diagram in accordance with aspects of the present disclosure.

FIG. 4 depicts an example scenario in accordance with aspects of the present disclosure.

FIG. 5 depicts an example scenario in accordance with aspects of the present disclosure.

FIG. 6 illustrates an example implementation of a data manager module in accordance with aspects of the present disclosure.

FIG. 7 illustrates an example implementation of a data manager module in accordance with aspects of the present disclosure.

FIG. 8 illustrates an example implementation of a data manager module in accordance with aspects of the present disclosure.

FIG. 9 illustrates an example implementation of a data manager module in accordance with aspects of the present disclosure.

FIG. 10 depicts a scenario in accordance with aspects of the present disclosure.

FIG. 11 illustrates a flow chart depicting an example method for data control based on threat condition in accordance with one or more implementations.

FIG. 12 illustrates a flow chart depicting an example method for data control based on threat condition in accordance with one or more implementations.

FIG. 13 illustrates a flow chart depicting an example method for data control based on threat condition in accordance with one or more implementations.

FIG. 14 illustrates various components of an example device in which aspects of data control based on threat condition can be implemented.

### DETAILED DESCRIPTION

Techniques for data control based on threat condition are described and are implementable to control data transmission associated with data transactions (e.g., financial transactions, the transfer of high priority data, etc.) based on different state conditions. For instance, the described techniques enable a mobile device, based on detection of a threat condition, to transition to data restriction state where transmission of one or more data types (e.g., sensitive data such as financial transaction data) is blocked by the mobile device.

For example, consider a scenario in which a user is carrying a mobile device (e.g., a mobile phone) and is approached by a hostile party that demands access to the mobile phone. For instance, the hostile party threatens the user at gunpoint and demands that the user hand over the mobile phone. Further, the hostile party demands that the user unlock the mobile device and provide authentication information (e.g., password, PIN, biometric authentication, etc.) to access a finance application on the mobile device. The hostile party, for example, may wish to utilize the finance application to transfer value from the user's account to an account associated with the hostile party.

Accordingly, in such a scenario, techniques described herein can be employed to detect that the user may be under a threat condition and to block transmission of sensitive data by the mobile device, e.g., user data associated with the finance application. For instance, sensors on the mobile device can collect sensor input such as user motion, biometric input, user physiological attributes, voice input, etc. Further, the sensor input can be correlated to a threat condition trigger that indicates that the user is under a threat condition. The sensor input, for example, can indicate excessive user distress such as user shaking (motion), highly elevated heart rate, user perspiration, voice input, etc., that can be indicative of a threat condition. Alternatively or additionally, the sensor input can indicate a user gesture (e.g., touch gesture) to the mobile device triggering a threat condition.

Accordingly, based on the threat condition trigger, the mobile device can transition to a transmit restriction state where one or more data types can be blocked from being transmitted by the mobile device. For instance, after valid authentication information for the finance application is provided, the hostile party may attempt to perform a transaction to transfer value from the user's account to an account associated with the hostile party. In the transmit restriction state, however, the mobile device can block (e.g., prevent) transmission of data associated with the transaction by the mobile device. For example, and as further detailed below, data packets associated with the transaction can be blocked from transmission by the mobile device. Further, the mobile device, such as via the finance application, can output an error message indicating that a transmission error and/or a network error has occurred such that the transaction cannot be completed. Thus, the attempted transaction may fail to perform the transfer of value from the user's account to the account associated with the hostile party.

In implementations, different data types can be defined for a transmit restriction state. For instance, restricted data types and allowed data types can be defined. The restricted data types may represent data types that are not permitted to be transmitted in a transmit restriction state, and allowed data types may represent data types that are permitted to be transmitted in a transmit restriction state. Examples of the restricted data types include data associated with sensitive data applications, such as finance data, user credential data, protected files, etc. Examples of allowed data include voice data, positioning data, emergency services data etc. Thus, while in a transmit restriction state, certain types of data may be permitted to be transmitted by the mobile device, such as data associated with user safety, data for determining user location, etc.

Accordingly, techniques for data control based on threat condition can be implemented to protect user data and thus provide increased data security, such as in user threat situations.

While the examples above are discussed in the context of financial transactions, it is to be appreciated that the described techniques are equally applicable to other types of data transactions, such as the transfer of sensitive data. Examples of sensitive data include security-related data (e.g., passwords, personal identification numbers (PIN), security keys, etc.), national identification numbers, proprietary and/or confidential enterprise data, health data, insurance data, etc. Accordingly, an attempt to transmit and/or access sensitive data may be restricted and/or denied, such as based on various transaction constraints such as threat condition triggers.

Thus, techniques described herein enable data transmission as part of data transactions to be controlled based on detection of potential user threat conditions. In implementations, a data transaction represents a payment transaction, an attempt to transfer sensitive data, a login attempt, a password change attempt, etc. For instance, data transactions such as digital payment transactions involve generating, transmitting, and processing various types of data and across a variety of different systems and networks. Thus, digital payment transactions can be characterized as sets of computational operations much like other operations of a computing device and/or set of computing devices. Accordingly, by controlling data transactions based on potential user threat conditions, the described techniques can increase data security and conserve system resources (e.g., memory, processor bandwidth, network bandwidth, etc.) that may otherwise be used to detect and correct such data transactions, and thus the described techniques can improve the operation of computing devices and data networks.

While features and concepts of data control based on threat condition can be implemented in any number of environments and/or configurations, aspects of the described techniques are described in the context of the following example systems, devices, and methods. Further, the systems, devices, and methods described herein are interchangeable in various ways to provide for a wide variety of implementations and operational scenarios.

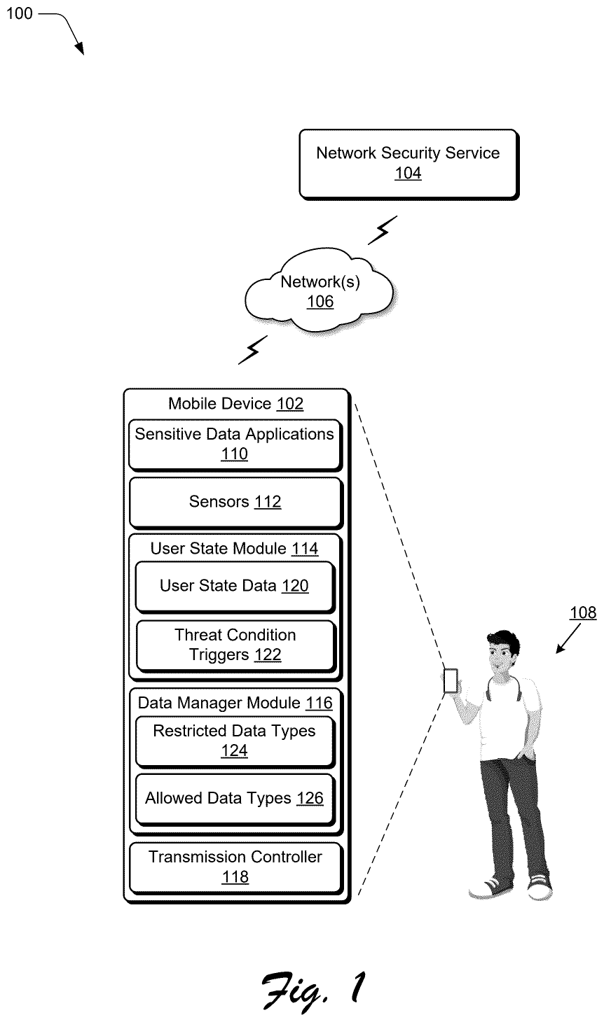

FIG. 1 illustrates an example environment 100 in which aspects of data control based on threat condition can be implemented. The environment 100 includes a mobile device 102, a network security service 104, and one or more network(s) 106. The mobile device 102 represents a device that can be used by a user 108 to perform different data transactions, e.g., finance transactions, transfer of sensitive data, etc. The mobile device 102, for instance, represents a device that can be carried by the user 108 to enable the user 108 to perform data transactions at different locations. The network security service 104 represents a network-based service that can communicate with the mobile device 102 (e.g., via the network(s) 106) to perform and/or assist with various operations pertaining to data control based on threat condition described herein.

The mobile device 102 includes functionality that is operable in association with techniques for data control based on threat condition described herein including sensitive data applications 110, sensors 112, a user state module 114, a data manager module 116, and a transmission controller 118. The sensitive data applications 110 represent functionality for performing various tasks that can involve sensitive data, such as financial applications, security applications, identity authentication applications, etc. A user 108 of the mobile device 102, for instance, can utilize the sensitive data applications 110 to perform different tasks that may involve the handling and/or transfer of sensitive data, such as digital representations of financial value, user account information, personally identifiable information (PII), etc.

The sensors 112 are representative of functionality to detect various physical and/or logical phenomena in relation to the mobile device 102, such as motion, light, image detection and recognition, time and date, position, location, touch detection, sound (e.g., voice), temperature, and so forth. Examples of the sensors 112 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth. The sensors 112, however, can include a variety of other sensor types in accordance with the implementations discussed herein.

The user state module 114 is representative of functionality to monitor and detect different user states in relation to the mobile device 102, such as user states associated with the user 108. For instance, the sensors 112 can generate sensor data that can be utilized by the user state module 114 to monitor user states of the user 108. As further detailed below, for example, the user state module 114 can utilize sensor data to generate user state data 120 that describes various user state attributes of the user 108. Further, the user state module 114 can utilize the user state data 120 to detect different threat condition triggers 122 that may indicate that the user 108 is in a threat state and/or under duress.

The data manager module 116 is representative of functionality to manage and monitor different data types for the mobile device 102, such as data that received, processed, and transmitted by the mobile device 102. The data manager module 116, for instance, can determine and/or identify restricted data types 124 and allowed data types 126. The restricted data types 124 can represent data types that are restricted from being transmitted by the mobile device 102 when a user threat condition is detected, such as by the user state module 114. Examples of the restricted data types 124 include background data, best effort data, and data that is determined to be security sensitive, e.g., data associated with the sensitive data applications 110. The allowed data types 126 can represent data types that are permitted to be transmitted by the mobile device 102 when a user threat condition is detected. Examples of the allowed data types 126 include video data (e.g., for video calls), voice data (e.g., for voice calls), emergency services data, location services data, etc.

The transmission controller 118 is representative of functionality to control data transmission (e.g., wireless data transmission) by the mobile device 102. In implementations the transmission controller 118 can represent a driver that interacts with transceiver functionality of the mobile device 102 to control which data types are permitted to be transmitted by the mobile device, such as when a user threat condition is detected. Additionally or alternatively to functionality implemented via the mobile device 102, different aspects of data control based on threat condition may be implemented via the network security service 104.

The mobile device 102 and the network security service 104 can be implemented in various ways and include various functionality, examples of which are discussed below with reference to the example device 1400 of FIG. 14. Further, the network(s) 106 can represent a combination of wired and wireless networks via which the mobile device 102 and the network security service 104 can participate in various types of communication, such as wired and/or wireless data communication.

Having discussed an example environment in which the disclosed techniques can be performed, consider now some example scenarios and implementation details for implementing the disclosed techniques.

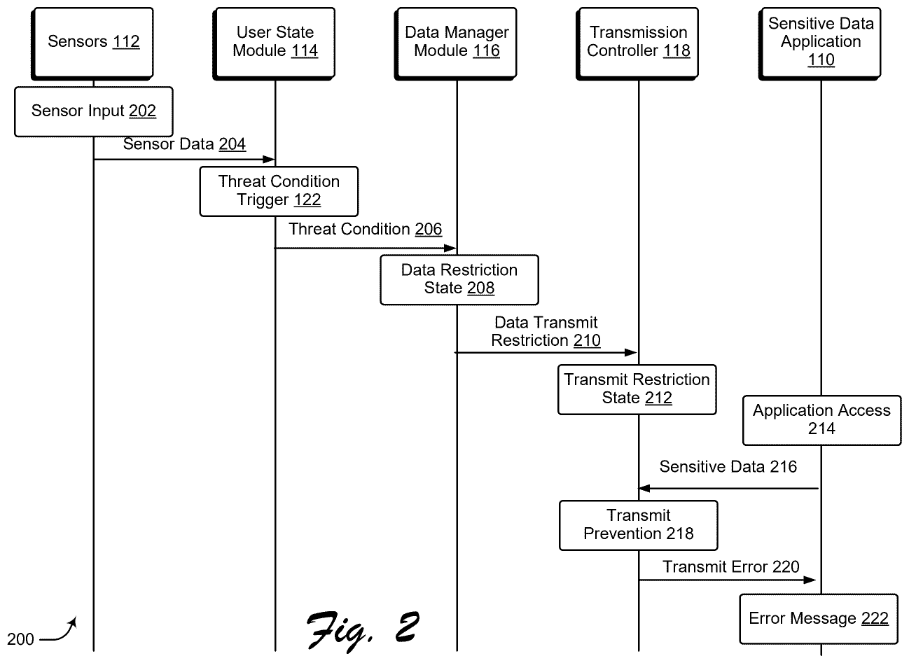

FIG. 2 illustrates a signaling diagram 200 in accordance with aspects of the present disclosure. In the signaling diagram, the sensors 112 receive sensor input 202, such as based on user behavior of the user 108. Examples of the sensor input 202 include motion, biometric input (e.g., heart rate, skin temperature), user physiological attributes, audio input (e.g., voice input), user gestures (e.g., touch gestures), etc. Based on the sensor input 202 the sensors 112 communicate sensor data 204 to the user state module 114 and the user state module 114 detects, based at least in part on the sensor data 204, a threat condition trigger 122. The sensor data 204, for instance, indicates that the user 108 may be in a threated state. Examples of sensor data 204 that can cause the threat condition trigger 122 include a heart rate that exceeds a threshold heart rate, excessive shaking motion, voice data indicating a hostile situation, combinations thereof, etc. As another example the sensor data 204 can include an indication of a user gesture (e.g., touch gesture) to the mobile device 102 that indicates that the user 108 is in a threat condition. For instance, custom user gestures can be defined that indicate (e.g., map to) a threat condition.

In response to the threat condition trigger 122, the user state module 114 communicates a threat condition notification 206 to the data manager module 116 indicating that the user 108 of the mobile device 102 is in a threated state. Accordingly, the data manager module 116 implements a data restriction state 208. For instance, in the data restriction state 208, the restricted data types 124 are to be prevented from being transmitted by the mobile device 102. The data manager module 116 then communicates a data transmit restriction notification 210 to the transmission controller 118 indicating that transmission of at least restricted data types 124 by the mobile device 102 is to be disallowed. In response to the data transmit restriction notification 210 the transmission controller 118 implements a transmit restriction state 212 where one or data types (e.g., the restricted data types 124) are disallowed (e.g., prevented) from being transmitted by the mobile device 102.

Further to the signaling diagram 200, an application access event 214 occurs at a sensitive data application 110. For instance, while the transmit restriction state 212 is active, the application access event 214 occurs indicating interaction with the sensitive data application 110. As part of the application access event 214, sensitive data 216 is generated by the sensitive data application 110 and communicated to the transmission controller 118 for transmission by the mobile device 102. Examples of the sensitive data 216 include user authentication and/or authorization information (e.g., passwords, personal identification numbers (PINs), biometric data, etc.), financial transaction data, data labeled as being sensitive (e.g., protected data), etc. Alternatively or additionally the sensitive data 216 can represent any data generated by and/or associated with a sensitive data application 110. For instance, the sensitive data 216 can be tagged and/or labeled as sensitive data and/or can be tagged and/or labeled as data associated with a sensitive data application 110. Alternatively or additionally the sensitive data 216 can be determined to be sensitive data based on the sensitive data application 110 being an active (e.g., foreground) application on the mobile device 102.

The transmission controller 118 can implement a transmit prevention action 218 to prevent transmission of the sensitive data 216 by the mobile device 102. For instance, the transmission controller 118 can disable transmission of different data types by the mobile device 102, such as by disabling transmission of restricted data types. In examples the transmission controller 118 can disable wireless local area network (WLAN) transmit (Tx) data packets, wide area network (WAN) Tx data packets, etc., associated with the sensitive data 216.

Based at least in part on performing the transmit prevention action 218, the transmission controller 118 can communicate a transmit error message 220 indicating that the sensitive data 216 could not be transmitted. The transmit error message 220, for instance, can indicate that a network connectivity error occurred and that data from the sensitive data application 110 could not be transmitted by the mobile device 102. Based at least in part on the transmit error message 220, the sensitive data application 110 can output an error message 222 indicating that the sensitive data 216 could not be transmitted. The error message 222, for instance, can represent a visual and/or audible notification indicating that a connectivity error occurred in attempting to transmit data pertaining to a transaction associated with the sensitive data application 110. Examples of the error message 222 are described below and in the accompanying figures.

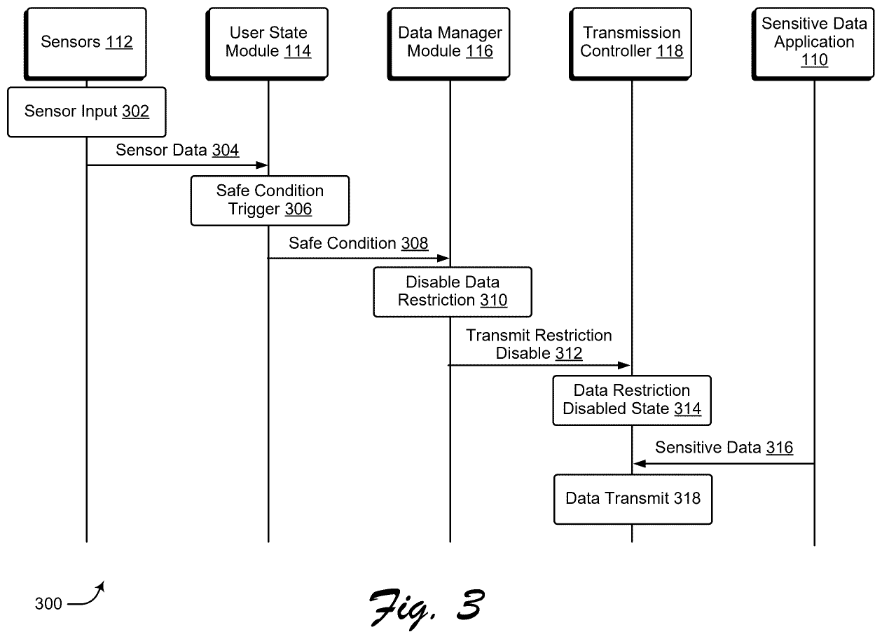

FIG. 3 illustrates a signaling diagram 300 in accordance with aspects of the present disclosure. The signaling diagram 300, for instance, represents operations and/or actions that can occur after the operations/actions described with reference to the signaling diagram 200. In the signaling diagram 300 the sensors 112 receive sensor input 302, examples of which are described throughout this disclosure. Based at least in part on the sensor input 302, the sensors 112 generate sensor data 304 and communicate the sensor data 304 to the user state module 114. The user state module 114 can determine, based at least in part on the sensor data 304, a safe condition trigger 306. The safe condition trigger 306, for instance, can indicate that a threat condition associated with the user 108 and/or the mobile device 102 has been removed. In implementations, the safe condition trigger 306 can be based, at least in part, on a user action to specify that a threat condition has been removed, such as a user input (e.g., password input, touch gesture, voice input, etc.) clearing the threat condition.

Accordingly, based at least in part on the safe condition trigger 306, the user state module 114 can communicate a safe condition notification 308 to the data manager module 116 and the data manager module 116 can perform a disable data restriction action 310. The disable data restriction action 310, for instance, can disable the data restriction state 208. The data manager module 116 can then communicate a transmit restriction disable message 312 to the transmission controller 118 and the transmission controller 118 can implement a data restriction disabled state 314. For instance, in the data restriction disabled state 314, no data types are prevented from being transmitted by the mobile device 102, e.g., all data types are permitted to be transmitted by the mobile device 102. For example, sensitive data 316 provided by a sensitive data application 110 is permitted to be transmitted by the mobile device 102 at a data transmit action 318.

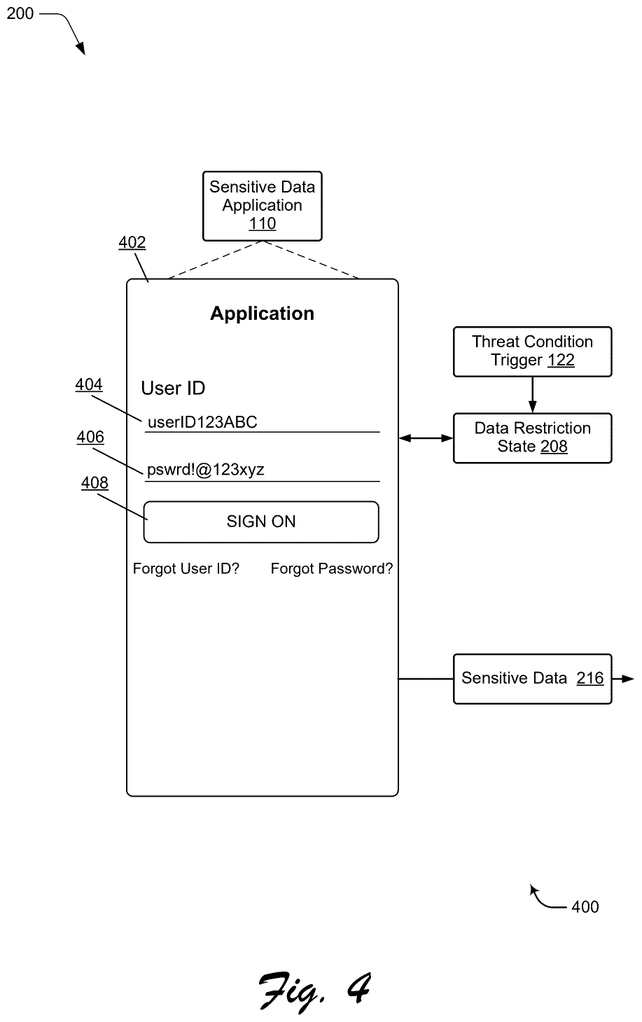

FIG. 4 depicts an example scenario 400 in accordance with aspects of the present disclosure. In the scenario 400 a threat condition trigger 122 is detected and in response, the mobile device 102 is transition to a data restriction state, such as described above. Further, a sensitive data application 110 is active on the mobile device 102 and an application GUI 402 for the sensitive data application 110 is displayed. The application GUI 402, for instance, includes a user identifier (ID) field 404 and a password field 406 for entering authentication credentials for the sensitive data application 110. Accordingly, while the user 108 is detected to be under a threat condition and the data restriction state 208 is active, a user ID is entered into the user ID field 404 and a password is entered into the password field 406. According to implementations, the entered user ID and password represent valid user credentials for accessing a user account with the sensitive data application 110.

Further to the scenario 400 the user 108 selects a sign on control 408 to attempt to sign on (e.g., login) to the sensitive data application 110. For instance, the sensitive data 216 includes the user ID and password submitted for transmission by the mobile device 102 while the data restriction state 208 is active.

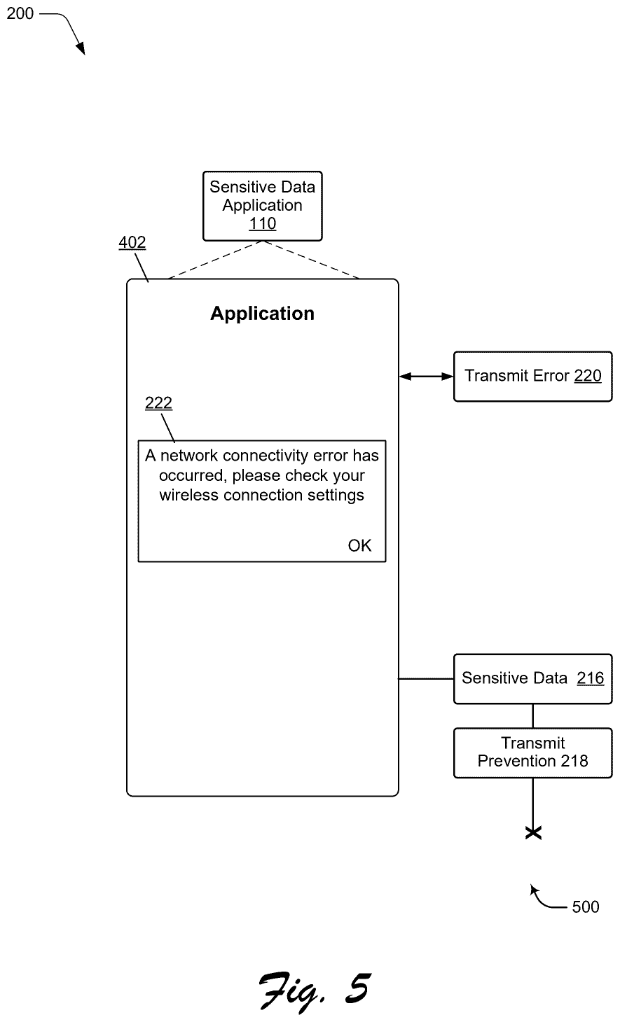

FIG. 5 depicts an example scenario 500 in accordance with aspects of the present disclosure. The scenario 500, for instance, represents a continuation and/or extension of the scenario 400. In the scenario 500, in response to the transmit error message 220, an error message 222 is output via the mobile device 102. For instance, the error message 222 can be output as part of the application GUI 402 for the sensitive data application 110. In at least one implementation the error message 222 indicates that a network connectivity error has occurred, e.g., that network connectivity is not currently available and/or a network service associated with the sensitive data application 110 is not current available, e.g., accessible. Thus, a transmit prevention action 218 prevents the sensitive data 216 is prevented from being transmitted by the mobile device 102.

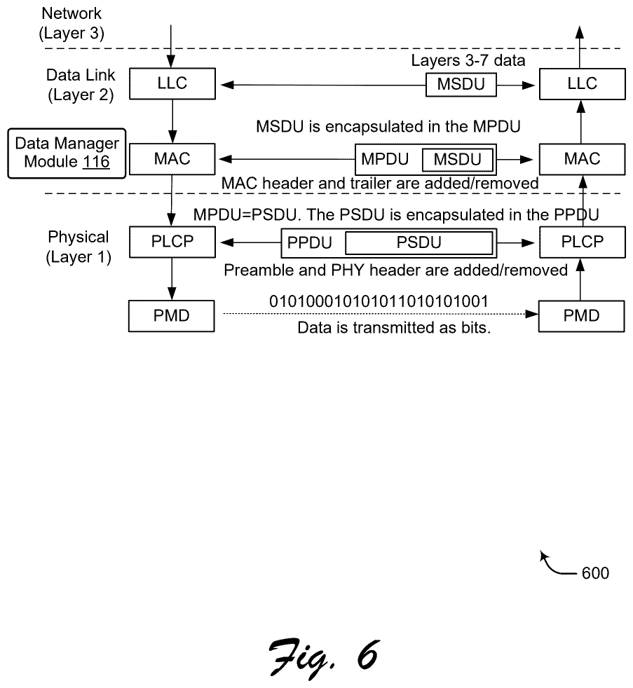

FIG. 6 illustrates an example implementation 600 of a data manager module 116 in accordance with aspects of the present disclosure. In the implementation 600 the data manager module 116 can be implemented as part of a data link layer, e.g., Layer 2 in an Open System Interconnection (OSI) system layer architecture. This can enable the data manager module 116 to monitor different data types and block transmission of certain data types (e.g., restricted data types 124) when a threat condition is active in response to a threat condition trigger 122.

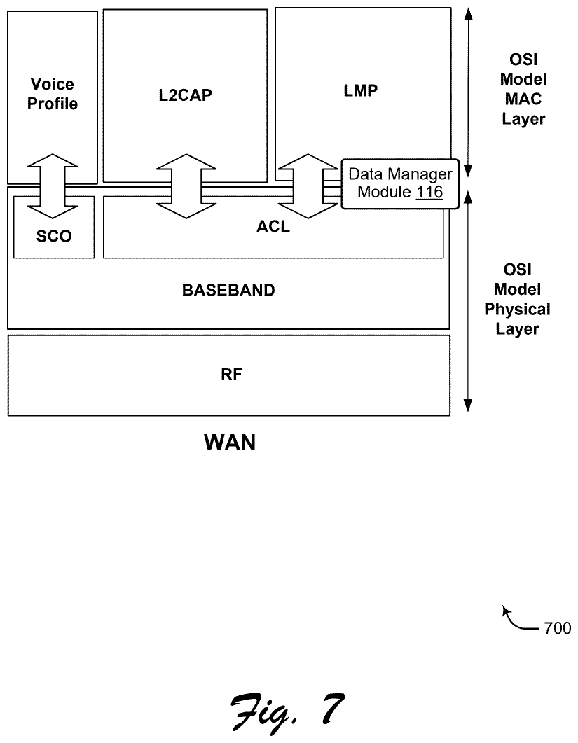

FIG. 7 illustrates an example implementation 700 of a data manager module 116 in accordance with aspects of the present disclosure. In the implementation 700 the data manager module 116 can be implemented in conjunction with a medium access control (MAC) layer and a physical layer of a WAN OSI system layer architecture.

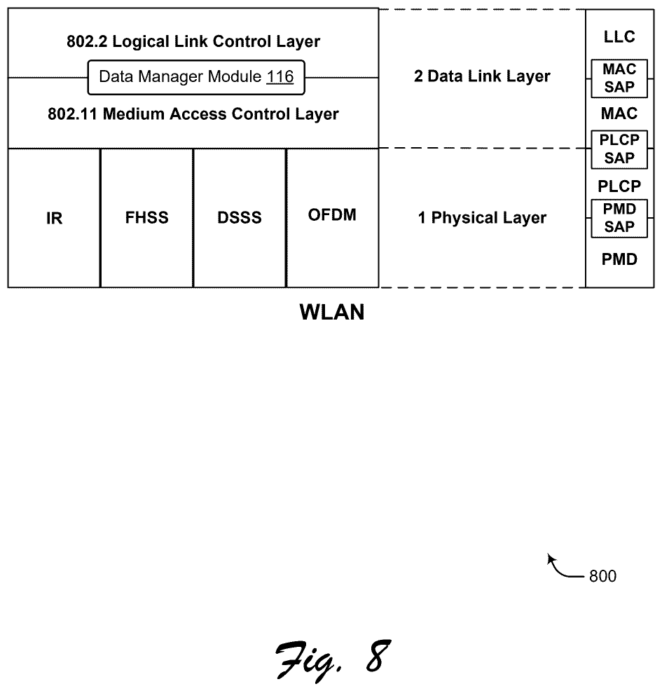

FIG. 8 illustrates an example implementation 800 of a data manager module 116 in accordance with aspects of the present disclosure. In the implementation 800 the data manager module 116 can be implemented in conjunction with a logical link control layer (LLC) and a MAC layer of a WLAN OSI system layer architecture.

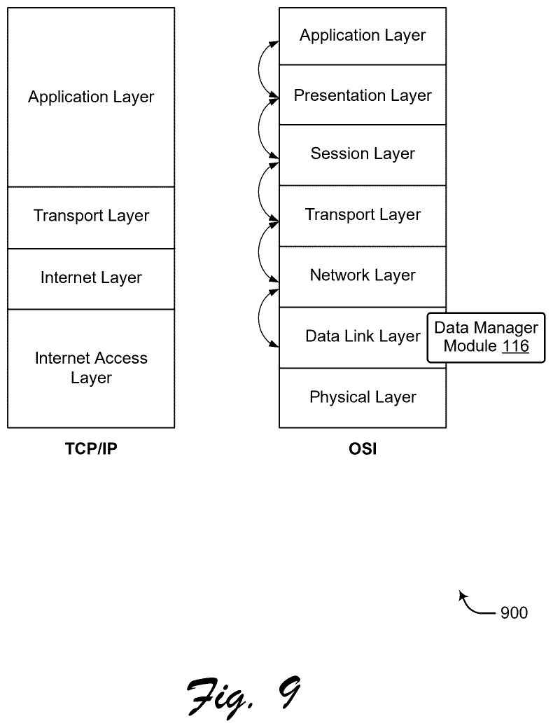

FIG. 9 illustrates an example implementation 900 of a data manager module 116 in accordance with aspects of the present disclosure. In the implementation 900 the data manager module 116 can be implemented at a data link layer of an OSI system layer architecture.

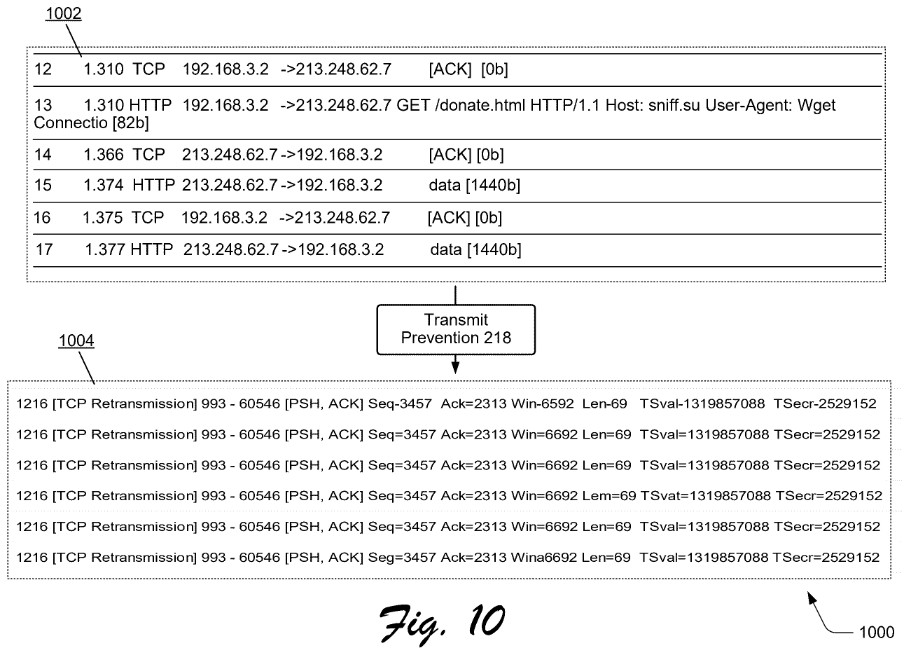

FIG. 10 depicts a scenario 1000 in accordance with aspects of the present disclosure. In the scenario 1000 at 1002 the data manager module 116 detects, while the data restriction state 208 is active, that data 1002 of a restricted data type 124 is submitted for transmission by the mobile device 102. Accordingly, the data manager module 116 implements the transmit prevention action 218 to prevent transmission of the restricted data type 124. For instance, disabled transmit packets 1004 represent data packets of the restricted data type 124 that are prevented (e.g., blocked) from being transmitted by the mobile device 102.

FIG. 11 illustrates a flow chart depicting an example method 1100 for data control based on threat condition in accordance with one or more implementations. Operations of the method 1100, for instance, may be performed in the context of the environment 100, such as by the mobile device 102 and/or the network security service 104.

At 1102 sensor data is received indicating one or more threat condition triggers associated with a user of the mobile device. The user state module 114, for instance, receives sensor data from the sensors indicating a threat condition trigger 122. Further, the user state module 114 can communicate a threat condition notification to the data manager module 116.

At 1104 a data control process is executed, based at least in part on the one or more threat condition triggers, to restrict one or more first data types from being transmitted by the mobile device. The data manager module 116, for instance, signals the transmission controller 118 to block transmission of one or more restricted data types 124. For instance, while the mobile device 102 is considered to be under a threat condition and/or a transmit restriction state 212, data packets associated with at least the one or more first data types (e.g., restricted data types 124) are blocked from being transmitted by the mobile device 102.

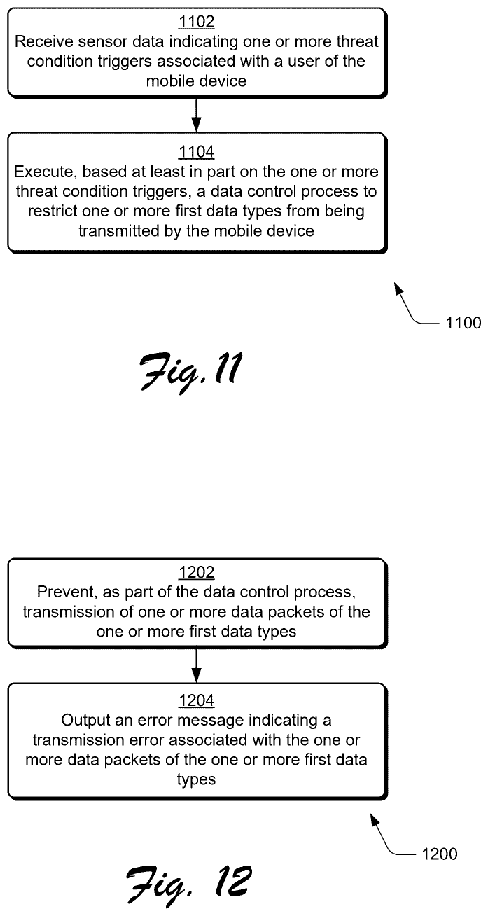

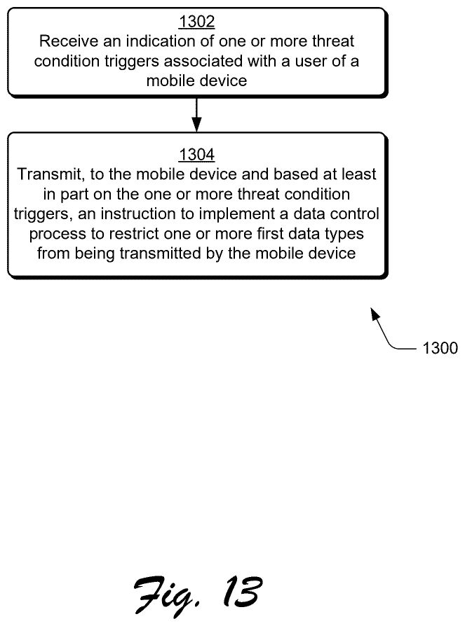

FIG. 12 illustrates a flow chart depicting an example method 1200 for data control based on threat condition in accordance with one or more implementations. Operations of the method 1200, for instance, may be performed in the context of the environment 100, such as by the mobile device 102 and/or the network security service 104.

At 1202, as part of the data control process, transmission of one or more data packets of the one or more first data types is prevented. The transmission controller 118, for example, detects one or more data packets of a restricted data type 124 and blocks transmission of the one or more data packets.

At 1204 an error message indicating a transmission error associated with the one or more data packets of the one or more first data types is output. For example, the mobile device 102 (e.g., via a sensitive data application 110) outputs an error message indicating that an error in data transmission and/or an error in network connectivity occurred such that the requested data is unable to be successfully transmitted.

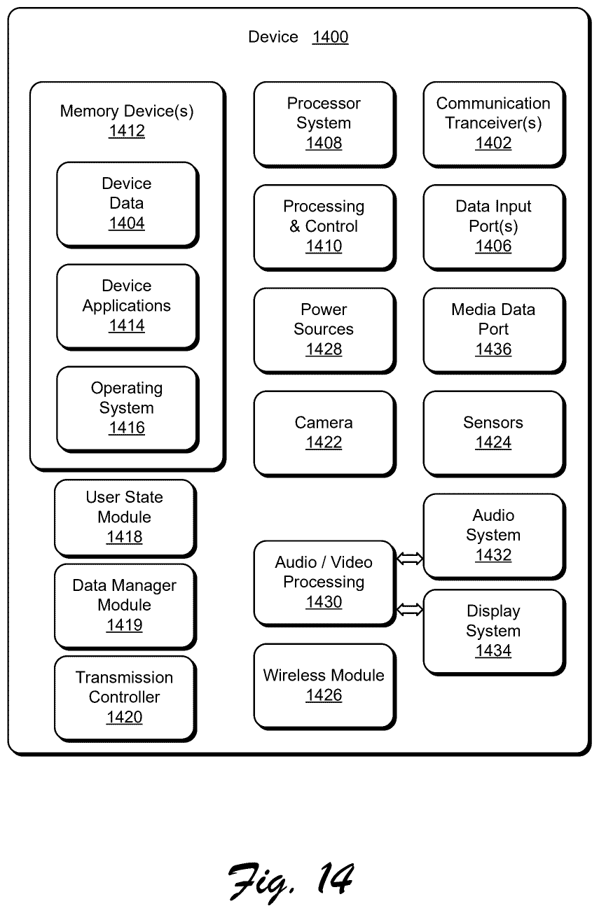

FIG. 13 illustrates a flow chart depicting an example method 1300 for data control based on threat condition in accordance with one or more implementations. Operations of the method 1300, for instance, may be performed in the context of the environment 100, such as by the mobile device 102 and/or the network security service 104.

At 1302 an indication of one or more threat condition triggers associated with a user of a mobile device is received. The network security service 104, for instance, receives a notification from the mobile device 102 of one or more threat condition triggers 122 associated with the mobile device 102. In at least one implementation the user state module 114 can generate the notification and cause the notification to be transmitted to the network security service 104.

At 1304 an instruction is transmitted, to the mobile device and based at least in part on the one or more threat condition triggers, to implement a data control process to restrict one or more first data types from being transmitted by the mobile device. The network security service 104, for instance, transmits a notification to the mobile device to transition to a transmit restriction state 212. In response to receiving the notification/instruction, the mobile device 102 can enter the transmit restriction state 212.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 14 illustrates various components of an example device 1400 in which aspects of data control based on threat condition can be implemented. The example device 1400 can be implemented as any of the devices described with reference to the previous FIGS. 1-13, such as any type of mobile device, mobile phone, mobile device, wearable device, tablet, computing, communication, entertainment, gaming, media playback, and/or other type of electronic device. For example, the mobile device 102 and/or the network security service 104 as shown and described with reference to FIGS. 1-13 may be implemented as the example device 1400.

The device 1400 includes communication transceivers 1402 that enable wired and/or wireless communication of device data 1404 with other devices. The device data 1404 can include one or more of device identifying data, device location data, wireless connectivity data, and wireless protocol data. Additionally, the device data 1404 can include any type of audio, video, and/or image data. Example communication transceivers 1402 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 1400 may also include one or more data input ports 1406 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 1400 includes a processing system 1408 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 1410. The device 1400 may further include any type of a system bus or other data and command transfer system that couples the various components within the device. A system bus can include any one or combination of different bus structures and architectures, as well as control and data lines.

The device 1400 also includes computer-readable storage memory 1412 (e.g., memory devices) that enable data storage, such as data storage devices that can be accessed by a computing device, and that provide persistent storage of data and executable instructions (e.g., software applications, programs, functions, and the like). Examples of the computer-readable storage memory 1412 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 1400 may also include a mass storage media device.

The computer-readable storage memory 1412 provides data storage mechanisms to store the device data 1404, other types of information and/or data, and various device applications 1414 (e.g., software applications). For example, an operating system 1416 can be maintained as software instructions with a memory device and executed by the processing system 1408. The device applications may also include a device manager, such as any form of a control application, software application, signal-processing and control module, code that is native to a particular device, a hardware abstraction layer for a particular device, and so on. Computer-readable storage memory 1412 represents media and/or devices that enable persistent and/or non-transitory storage of information in contrast to mere signal transmission, carrier waves, or signals per se. Computer-readable storage memory 1412 do not include signals per se or transitory signals.

In this example, the device 1400 includes a user state module 1418, a data manager module 1419, and transmission controller 1420 that can implement aspects of data control based on threat condition and may be implemented with hardware components and/or in software. For example, the user state module 1418 can be implemented as the user state module 114, the data manager module 1419 can be implemented as the data manager module 116, and the transmission controller 1420 can be implemented as the transmission controller 118, described in detail above. In implementations, the user state module 1418, the data manager module 1419, and/or the transmission controller 1420 may include independent processing, memory, and logic components as a computing and/or electronic device integrated with the device 1400. Further, the transmission controller 1420 may be operable to control transmission of data packets by the device 1400 (e.g., via control of the communication transceiver(s) 1402), such as described throughout this disclosure.

In this example, the example device 1400 also includes a camera 1422 and sensors 1424. The sensors 1424 can be implemented in various ways and are representative of functionality to detect various physical and/or logical phenomena in relation to the device 1400, such as motion, light, image detection and recognition, time and date, position, location, touch detection, sound, temperature, and so forth. Examples of the sensors 1424 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth.

The device 1400 also includes a wireless module 1426, which is representative of functionality to perform various wireless communication tasks. The device 1400 can also include one or more power sources 1428, such as when the device is implemented as a mobile device. The power sources 1428 may include a charging and/or power system, and can be implemented as a flexible strip battery, a rechargeable battery, a charged super-capacitor, and/or any other type of active or passive power source.

The device 1400 also includes an audio and/or video processing system 1430 that generates audio data for an audio system 1432 and/or generates display data for a display system 1434. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1436. In implementations, the audio system and/or the display system are integrated components of the example device. Alternatively, the audio system and/or the display system are external, peripheral components to the example device.

Although implementations of data control based on threat condition have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:
In some aspects, the techniques described herein relate to a mobile device including: at least one memory; and at least one processor coupled with the at least one memory and configured to cause the mobile device to: receive sensor data indicating one or more threat condition triggers associated with a user of the mobile device; and execute, based at least in part on the one or more threat condition triggers, a data control process to restrict one or more first data types from being transmitted by the mobile device.

In some aspects, the techniques described herein relate to a mobile device, wherein the sensor data includes at least one of one or more biometric attributes of the user or one or more physiological attributes of the user, and wherein the one or more threat condition triggers are based at least in part on the at least one of the one or more biometric attributes of the user or the one or more physiological attributes of the user.

In some aspects, the techniques described herein relate to a mobile device, wherein the sensor data includes an indication of a user gesture that maps to the one or more threat condition triggers.

In some aspects, the techniques described herein relate to a mobile device, wherein the one or more first data types include one or more of best effort data or background data.

In some aspects, the techniques described herein relate to a mobile device, wherein to implement the data control process, the at least one processor is configured to cause the mobile device to prevent transmission of the one or more first data types via one or more of a wide area network (WAN) or a wireless local area network (WLAN).

In some aspects, the techniques described herein relate to a mobile device, wherein the at least one processor is configured to cause the mobile device to: prevent, as part of the data control process, transmission of one or more data packets of the one or more first data types; and output an error message indicating a transmission error associated with the one or more data packets of the one or more first data types.

In some aspects, the techniques described herein relate to a mobile device, wherein the one or more data packets of the one or more first data types includes sensitive data associated with a sensitive data application of the mobile device.

In some aspects, the techniques described herein relate to a mobile device, wherein the one or more data packets of the one or more first data types are tagged as sensitive data associated with the sensitive data application of the mobile device.

In some aspects, the techniques described herein relate to a mobile device, wherein the data control process allows one or more second data types to be transmitted by the mobile device while the one or more first data types are prevented from being transmitted by the mobile device.

In some aspects, the techniques described herein relate to a mobile device, wherein the one or more second data types are associated with one or more of a location service or an emergency service.

In some aspects, the techniques described herein relate to a method performed by a mobile device, the method including: receiving sensor data indicating one or more threat condition triggers associated with a user of the mobile device; and executing, based at least in part on the one or more threat condition triggers, a data control process to restrict one or more first data types from being transmitted by the mobile device.

In some aspects, the techniques described herein relate to a method, wherein the sensor data includes at least one of: one or more biometric attributes of the user or one or more physiological attributes of the user; or an indication of a user gesture that maps to the one or more threat condition triggers, wherein the one or more threat condition triggers are based at least in part on the at least one of the one or more biometric attributes of the user, the one or more physiological attributes of the user, or the indication of the user gesture.

In some aspects, the techniques described herein relate to a method, wherein the one or more first data types include one or more of best effort data or background data.

In some aspects, the techniques described herein relate to a method, wherein implementing the data control process includes preventing transmission of the one or more first data types via one or more of a wide area network (WAN) or a wireless local area network (WLAN).

In some aspects, the techniques described herein relate to a method, further including: preventing, as part of the data control process, transmission of one or more data packets of the one or more first data types; and outputting an error message indicating a transmission error associated with the one or more data packets of the one or more first data types.

In some aspects, the techniques described herein relate to a method, wherein the one or more data packets of the one or more first data types includes sensitive data associated with a sensitive data application of the mobile device.

In some aspects, the techniques described herein relate to a method, wherein executing the data control process includes allowing one or more second data types to be transmitted by the mobile device while the one or more first data types are prevented from being transmitted by the mobile device.

In some aspects, the techniques described herein relate to a system including: at least one memory; and at least one processor coupled to the at least one memory and configured to cause the system to: receive an indication of one or more threat condition triggers associated with a user of a mobile device; and transmit, to the mobile device and based at least in part on the one or more threat condition triggers, an instruction to implement a data control process to restrict one or more first data types from being transmitted by the mobile device.

In some aspects, the techniques described herein relate to a system, wherein the one or more first data types include one or more of best effort data or background data.

In some aspects, the techniques described herein relate to a system, wherein the instruction to implement the data control process further includes an instruction to allow one or more second data types to be transmitted by the mobile device while the one or more first data types are prevented from being transmitted by the mobile device.

1. A mobile device comprising:
at least one memory; and
at least one processor coupled with the at least one memory and configured to cause the mobile device to:
receive sensor data indicating one or more threat condition triggers associated with a user of the mobile device; and
execute, based at least in part on the one or more threat condition triggers, a data control process to restrict one or more first data types from being transmitted by the mobile device.

2. The mobile device of claim 1, wherein the sensor data comprises at least one of one or more biometric attributes of the user or one or more physiological attributes of the user, and wherein the one or more threat condition triggers are based at least in part on the at least one of the one or more biometric attributes of the user or the one or more physiological attributes of the user.

3. The mobile device of claim 1, wherein the sensor data comprises an indication of a user gesture that maps to the one or more threat condition triggers.

4. The mobile device of claim 1, wherein the one or more first data types comprise one or more of best effort data or background data.

5. The mobile device of claim 1, wherein to implement the data control process, the at least one processor is configured to cause the mobile device to prevent transmission of the one or more first data types via one or more of a wide area network (WAN) or a wireless local area network (WLAN).

6. The mobile device of claim 1, wherein the at least one processor is configured to cause the mobile device to:
prevent, as part of the data control process, transmission of one or more data packets of the one or more first data types; and
output an error message indicating a transmission error associated with the one or more data packets of the one or more first data types.

7. The mobile device of claim 6, wherein the one or more data packets of the one or more first data types comprises sensitive data associated with a sensitive data application of the mobile device.

8. The mobile device of claim 7, wherein the one or more data packets of the one or more first data types are tagged as sensitive data associated with the sensitive data application of the mobile device.

9. The mobile device of claim 1, wherein the data control process allows one or more second data types to be transmitted by the mobile device while the one or more first data types are prevented from being transmitted by the mobile device.

10. The mobile device of claim 9, wherein the one or more second data types are associated with one or more of a location service or an emergency service.

11. A method performed by a mobile device, the method comprising:
receiving sensor data indicating one or more threat condition triggers associated with a user of the mobile device; and
executing, based at least in part on the one or more threat condition triggers, a data control process to restrict one or more first data types from being transmitted by the mobile device.

12. The method of claim 11, wherein the sensor data comprises at least one of:
one or more biometric attributes of the user or one or more physiological attributes of the user; or
an indication of a user gesture that maps to the one or more threat condition triggers, wherein the one or more threat condition triggers are based at least in part on the at least one of the one or more biometric attributes of the user, the one or more physiological attributes of the user, or the indication of the user gesture.

13. The method of claim 11, wherein the one or more first data types comprise one or more of best effort data or background data.

14. The method of claim 11, wherein implementing the data control process comprises preventing transmission of the one or more first data types via one or more of a wide area network (WAN) or a wireless local area network (WLAN).

15. The method of claim 11, further comprising:
preventing, as part of the data control process, transmission of one or more data packets of the one or more first data types; and
outputting an error message indicating a transmission error associated with the one or more data packets of the one or more first data types.

16. The method of claim 15, wherein the one or more data packets of the one or more first data types comprises sensitive data associated with a sensitive data application of the mobile device.

17. The method of claim 11, wherein executing the data control process comprises allowing one or more second data types to be transmitted by the mobile device while the one or more first data types are prevented from being transmitted by the mobile device.

18. A system comprising:
at least one memory; and
at least one processor coupled to the at least one memory and configured to cause the system to:
receive an indication of one or more threat condition triggers associated with a user of a mobile device; and
transmit, to the mobile device and based at least in part on the one or more threat condition triggers, an instruction to implement a data control process to restrict one or more first data types from being transmitted by the mobile device.

19. The system of claim 18, wherein the one or more first data types comprise one or more of best effort data or background data.

20. The system of claim 18, wherein the instruction to implement the data control process further comprises an instruction to allow one or more second data types to be transmitted by the mobile device while the one or more first data types are prevented from being transmitted by the mobile device.
